(19) United States
(12) Patent Application Publication
(10) Pub. No.: US 2010/0080932 A1
(43) Pub. Date: Apr. 1, 2010

(54) METHOD FOR SELECTIVELY FUNCTIONALIZING NON-MODIFIED SOLID SURFACE AND METHOD FOR IMMOBILIZING ACTIVE MATERIAL ON THE FUNCTIONALIZED SOLID SURFACE

(75) Inventors: An-soon Kim, Daejon (KR); Han-Young Yu, Daejon (KR); In-Bok Baek, Chungbuk (KR); Jong-Heon Yang, Daejon (KR); Chang-Geun Ahn, Daejon (KR); Chan-Woo Park, Daejon (KR); Seong-Jae Lee, Daejon (KR); Chil-Seong Ah, Daejon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/517,193

(22) PCT Filed: May 14, 2007
(86) PCT No.: PCT/KR2007/002356

§ 371 Date: Jun. 1, 2009

(30) Foreign Application Priority Data
Dec. 7, 2006 (KR) 10-2006-0123685

(51) Int. Cl. B05D 3/06

(52) U.S. Cl. 427/558; 427/553; 427/551; 427/557

(57) ABSTRACT

Provided is a method for selectively functionalizing unmodified solid surface, not oxidized and nitrified, into an aldehyde group, and a method for immobilizing an active material such as bio material or functional material on the functionalized aldehyde solid surface through strong and stable chemical bonding. Differently from a conventional method immobilizing deoxyribonucleic acid (DNA) using a cross linker, the method of the present invention does not require a cross linker reaction step to thereby shorten a process. Also, since a cross linker is absent, the monomolecular layer on the surface of a device is thin, which reduces a perturbation effect by molecular layer. This is useful in fabrication of molecular electronic devices and bio-active devices. In addition, since the bio material or functional material is selectively immobilized only on the unmodified surface, the present invention can functionalize only a specific solid surface and develop a highly sensitive sensor and an improved functional device.

### TECHNICAL FIELD

The present invention relates to a method for selectively functionalizing a unmodified solid surface and a method for immobilizing an active material on the functionalized solid surface; and, more particularly, to a method for selectively functionalizing a unmodified solid surface, which is not oxidized and functionalized, to an aldehyde group, and a method for immobilizing an active material such as a bio material or a functional material on the functionalized aldehyde solid surface through strong and stable chemical bonding.

### BACKGROUND ART

Bio-Technology (BT) and Nano-Technology (NT) have been spotlighted as technology that leads the 21^{st} century with Information-Technology field. Further, it is expected that the Bio-technology and Nano-technology will continue to advance by being joined with other technologies and industries rather than independently advancing. For this, it is important to functionalize a surface of a conventional electronic device by fusing a bio material or a functional material into a molecular level, for example, a nano meter level, and to control the characteristics of a conventional device. In order to develop it as a fusion technology, it is required to guarantee the long term stability of the functionalized surface with a bio material or a functional material, and it needs a technology for selectively functionalizing a desired surface.

In order to selectively functionalizing the desired surface, methods for fabricating a monomolecular film using a chemical self-assembly technique or a Langmuir-Blodget technique were introduced. Since the Langmuir-Blodget technique has limited materials to use due to weak physical absorption on a surface, the chemical self-assembly technique has been widely used.

Silanization reaction is one of representative chemical self-assembly technique, which functionalizes a solid surface through chemical bonding. Since the silanization reaction is very sensitive to external environment, it is very difficult to control reaction conditions for fabricating a monomolecular film. Furthermore, the functionalized surface is also easily modified such as oxidized if the functionalized surface is exposed to moisture or air. Since such an oxidized surface is chemically similar to glass, the surface is inhomogeneous and chemical diversity due to large number of chemical Si—O—Si and Si—OH bonds.

The inhomogeneous and chemical diversity makes it difficult to immobilize an active material such as deoxyribonucleic acid (DNA) or protein on the surface. Conventionally, a silicon substrate has been used for electronic devices. The silanization reaction has a limitation to selectively functionalize the silicon surface because the silanization functionalize both silicon oxide and silicon nitride.

In order to overcome such a problem, a method for selectively immobilizing DNA only on a silicon surface through strong and stable chemical boding was introduced by Robert J. Hamers at al., nanotechnology, 16, p 1868 (2005). In this method, a modified silicon surface, which is a silicon oxide surface, is not functionalized and only a silicon surface is functionalized into amino group. Then, the surface is functionalized into maleimide by adding a cross linker having a bifunctional group that can react with DNA, and the DNA is immobilized on the functionalized surface.

However, the conventional method adding the cross linker has shortcoming as follows. At first, it is difficult to use this method to a field effect transistor which requires a thin monomolecular film formed on a device surface to operate field effect. Secondly, it is not stable because of less reactivity between protein and the functionalized surface.

### DISCLOSURE

### Technical Problem

An embodiment of the present invention is directed to providing a method for fabricating a functionalized solid surface by selecting a thin monomolecular layer and unmodified solid surface such as an oxidized or a nitride solid surface without using a cross linker, and a method for strongly and stably immobilizing an active material such as a bio material or a functional material on the selected solid surface.

### Technical Solution

The present invention provides a method for efficiently immobilizing diverse active materials selectively on the unmodified solid surface, and a method for functionalizing only a solid surface selectively functionalized into an aldehyde group. The present invention can immobilize a bio material or a functional material on the functionalized solid surface through a strong and stable bonding.

To achieve the above technical object, in accordance with an aspect of the present invention, there is provided a method for selectively functionalizing an unmodified solid surface, which includes the steps of:

a) functionalizing an unmodified solid surface, which is not oxidized and nitrified, using a functional group that reacts with light;

b) introducing a chemical compound on the solid surface, which contains an aldehyde protecting group and a functional group that reacts with the functionalized surface;

c) forming surface-carbon bonding, surface-nitrogen bonding, or surface-sulfur bonding by radiating light on the solid surface, and functionalizing the surface end group to aldehyde protecting group; and

d) functionalizing the solid surface into aldehyde group by removing the protecting group from the solid surface functionalized with the aldehyde protecting group.

In addition, the present invention provides a method for immobilizing an active material on an unmodified solid surface, which includes the step of immobilizing an active material on a solid surface functionalized into aldehyde group using the method for claim 1.

### ADVANTAGEOUS EFFECTS

A method for selectively functionalizing an unmodified solid surface and a method for immobilizing an active material on the functionalized solid surface according to an embodiment of the present invention immobilize a bio material or a functional material on the functionalized solid surface without a cross linker. Since the method according to an embodiment of the present invention does not need a cross linker reaction step unlike a conventional method using a cross linker to immobilize deoxyribonucleic acid (DNA), the fabricating process can be simplified. Since the cross linker is not used, a monomolecular film on a surface of a material becomes thinner, thereby reducing perturbation effect caused by a molecular film. Therefore, molecular electronic devices or bio devices can be effectively manufactured using the method of the present invention. Since a bio material or a functional material is selectively immobilized on an unmodified surface, the method according to the present invention can be used to develop a high sensitive sensor or an advanced functional device by selectively functionalizing a predetermined solid surface.

### BRIEF DESCRIPTION OF THE DRAWINGS

FIG. 1 is a diagram illustrating a silicon substrate used for a method for selectively functionalizing a solid surface in accordance with an embodiment of the present invention.

FIG. 2 is a schematic illustration depicting a method for functionalizing unmodified silicon surface to aldehyde group in accordance with an embodiment of the present invention.

FIG. 3 is a schematic illustration showing a method for immobilizing Au-DNA conjugates on the silicon surface functionalized by the method for the first embodiment of the present invention.

FIG. 4 is a scanning electron microscope (SEM) image of an Au-DNA immobilized silicon substrate surface 100.

FIG. 5 is a SEM image of a silicon oxide substrate surface 101 without Au-DNA immobilized.

FIG. 6 is a schematic illustration of a method for immobilizing Au-IgG conjugates on a silicon surface functionalized by the functionalizing method for third embodiment.

FIG. 7 is a SEM image of an Au-IgG immobilized silicon substrate surface.

FIG. 8 is a magnified SEM image of an Au-IgG immobilized silicon substrate surface.

FIG. 9 is a magnified SEM image of an Au-IgG immobilized silicon oxide substrate surface.

### BEST MODE FOR THE INVENTION

The advantages, features and aspects of the invention will become apparent from the following description of the embodiments with reference to the accompanying drawings, which is set forth hereinafter.

A method for functionalizing a solid surface according to an embodiment of the present invention is characterized to selectively functionalize an unmodified solid surface only. In the present invention, the unmodified solid surface denotes a solid surface which is not oxidized or nitrified.

In the present invention, in order to form chemically active solid surface, an unmodified solid surface is firstly functionalized with a functional group that can react by light.

In an embodiment of the present invention, a functional group reacting with light denotes a functional group that can be bonded with other compound by light. The functional group is one selected from the group consisting of hydrogen, hydrocarbon, hydroxyl group, carbonyl group, amino group and thiol group. In an embodiment of the present invention, an unmodified solid surface is functionalized with hydrogen firstly. In order to functionalize the solid surface with hydrogen, the solid surface is immersed in about 0.01 to 10% a buffered oxide etch (BOE) solution, which is generally used as an etch solution in a semiconductor fabricating process. It is desirable to be reacted for about 0.01 second to 60 hours in the BOE solution. If the solid surface is immersed shorter than about 0.01 second, a naturally generated oxidation layer is not removed. If the solid surface is immersed longer than about 60 hours, a modified solid layer is removed. It is preferred to let the solid surface to be immersed in 2% BOE solution for about 1 to 60 seconds.

In the method for functionalizing an unmodified solid surface according to an embodiment of the present invention, it is preferable to use one selected from the group consisting of crystal or amorphous solid having group IV elements, semiconductor compound, plastic, polymer, and metal, as the solid.

In the method for functionalizing an unmodified solid surface according to an embodiment of the present invention, after firstly functionalizing the unmodified solid surface, a compound having an aldehyde protecting group is contacted onto the functionalized solid surface.

The contact into the firstly functionalized surface is made by adding a compound containing a functional group that reacts with a surface and includes an aldehyde protecting group. The functional group that reacts with the surface is one selected from the group consisting of an end or a branch, acyclic or cyclic unsaturated hydrocarbon group, thiol group, carbonyl group, carboxyl group, amino group, imino group, nitro group, hydroxyl group, phenyl group, nitrile group, isocyano group, and isotiocyano group. The aldehyde protecting group is one of acyclic acetal group and cyclic acetal group. It is preferable to use alkene alkoxy acetal as the compound having the functional group reacting with the surface and the aldehyde protecting group. It is further preferable to use 3-butenal diethyl acetal as the compound having the functional group reacting with the surface and the aldehyde protecting group. The end or branch unsaturated hydrocarbon group denotes unsaturated hydrocarbon in an end or a branch area.

Then, surface-carbon bonding, surface-nitrogen bonding, or surface-sulfur bonding by radiating light on the solid surface are formed, and a surface end is functionalized into aldehyde protecting group. In this step, one of infrared rays, visible rays, ultraviolet rays, and X-rays is radiated for about 1 minute to 24 hours. If the light is radiated shorter than about 1 minute, the surface is not reacted. If the light is radiated longer than about 24 hours, a multilayer thin film is formed. Therefore, it is preferable to radiate light within the above time range.

If the light is radiated as described above, strong chemical bonding, such as surface-carbon bonding, surface-nitrogen bonding, or surface-sulfur bonding, is formed, and a surface end is functionalized with aldehyde protecting group. In an embodiment of the present invention, the aldehyde protecting group denotes a functional group that can form aldehyde group by exposing an acid, a base, an oxidizing agent, a reducing agent, electricity, heat, or light. The functional group may be one of acyclic acetal group and cyclic acetal group. Then, the solid surface is functionalized into the aldehyde group by removing the protecting group from the functionalized surface.

The solid surface is functionalized into aldehyde group by exposing the solid surface to an acid, a base, an oxidizing agent, a reducing agent, electricity, heat, or light. In more detail, about 10 to 50% trifluoroacetic acid solution is used in an embodiment of the present invention. It is preferable that the trifluoroacetic acid solution reacts with the solid surface at about −10 to 60° C. for about 10 minutes to five hours.

If the reaction temperature is lower than −10° C., the reaction is slow and it is difficult to sustain the reaction environment. If the reaction temperature is higher than 60° C., the solvent is evaporated. Therefore, it is preferable to sustain the reaction temperature within the disclosed temperature range. Also, if the reaction time is shorter than about 10 minutes, the reaction does not occur. If the reaction time is longer than about 5 hours, a functionalized molecular layer on the solid surface is destroyed. Therefore, it is preferable to sustain the reaction time within the disclosed time range.

According to an embodiment of the present invention, a method for immobilizing an active material on an unmodified solid surface including the step of immobilizing an active material on a solid surface functionalized into aldehyde group through the above described method is provided.

The method for immobilizing an active material on an unmodified solid surface according to an embodiment of the present invention further includes the step of forming or substituting a functional group on an active material that reacts with aldehyde group before the active material is immobilized on a solid surface.

The functional group that reacts with the aldehyde group may be at least one selected from the group consisting of amino group, hydrazine group, hydrazone group, cyano group, isocyano group, isothiocyano group, halogen group, nitro group, alcohol group, thiol group, and grignard compound. However, the present invention is not limited thereto.

In an embodiment of the present invention, the active material is at least one of the group consisting of a bio material, a functional material, a nano material, and a polymer. The bio material may be DNA, RNA, antibody, antigen, oligo peptide, poly peptide, protein, enzyme, glucose, anti-cancer material, amino acid, cell, bacterium, or virus. The functional material may be an antibacterial active material, gas absorptive material, drug, molecule or polymer having memory characteristic, molecule or polymer having switching characteristic, magnetic material, or photonic material. The nano material is about 0.1 to 999 nm in size, quantum dot, nano particle, nano wire, nano tube, nano porosity material, nano rod, nano needle, nano powder, or nano cube. The polymer is carbon compound having nitrogen, oxygen, or sulfur, which have about 10000 of a molecular weight.

Hereinafter, the present invention will be described in detail by embodiments.

The following embodiments are only exemplary shown to describe the present invention. Therefore, the present invention is not limited thereto.

### 1^{st} Example

### Functionalization of Silicon Substrate Surface

1-1: Hydrogen Functionalization of Unmodified Silicon Substrate Surface

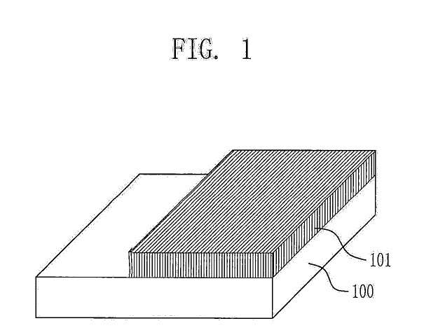

Referring to FIG. 1, a silicon substrate was immersed in 2% Buffered Oxide Etch (BOE; NH4F:HF=25:1) for 30 seconds. As a result, a modified silicon oxide substrate surface was not functionalized, and an unmodified silicon substrate surface was functionalized into hydrogen.

1-2: Aldehyde Group Functionalization of Hydrogen-Silicon Surface using Photo-Reaction

3-butenal diethyl acetal was added to the substrate surface functionalized like the embodiment 1-1. Then, unsaturated carbon of 3-butenal diethyl acetal was combined with the silicon substrate surface by radiating about 254 mm of ultraviolet rays and exposing the functionalized substrate at nitrogen atmosphere for about two hours. As a result, the end of the surface was functionalized into aldehyde protecting group (acetal). The modified silicon oxide substrate surface was not functionalized because the modified silicon oxide substrate surface does not have a silicon-hydrogen bond.

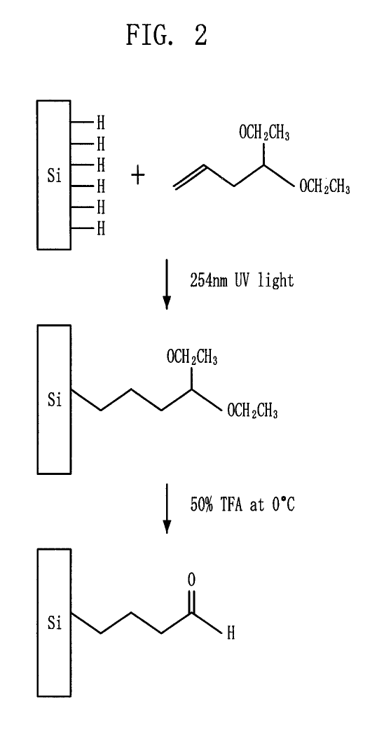

Then, in order to remove the protecting group, the substrate was immersed in a mixed solution having 50% trifluoroacetic acid dissolved in chloroform for about one and half hour at 0° C. As a result, the silicon substrate surface functionalized into aldehyde group was obtained. FIG. 2 shows schematic illustration of the functionalization of unmodified silicon surface to aldehyde group.

### 2^{nd} Embodiment

### Active Material Immobilization on Unmodified Silicon Substrate Surface

2-1: DNA Immobilization on Unmodified Silicon Substrate Surface

DNA containing 12 base sequences having end amino group is reacted with the silicon substrate surface functionalized into aldehyde group, which was obtained from the first embodiment, by exposing the DNA to the silicon surface in a reducing agent NaBH₃CN at room temperature for about five hours. As a result, the DNA was immobilized on the silicon surface through carbon-nitrogen bonding which was strong and stable chemical bonding. The aldehyde group on the silicon substrate surface formed the chemically stable carbon-nitrogen bonding through chemical reaction with DNA end amine, thereby immobilizing DNA only on the silicon substrate surface.

2-2: Protein Immobilization on Unmodified Silicon Surface

A human-immunoglobulin G (IgG) reacted with the silicon substrate surface functionalized into aldehyde group, which was obtained from the first embodiment, by exposing the IgG to the silicon surface in a reducing agent NaBH₃CN for about twelve hours, thereby immobilizing IgG on the silicon substrate surface.

### 1^{st} Experimental Example

### Experiment for Confirming the DNA Immobilization on Unmodified Silicon Substrate Surface

In order to confirm that DNA is immobilized only on an unmodified silicon substrate surface, an experiment was performed as follows. After remaining aldehyde group, which was unreacted with DNA in the embodiment 2-1, was blocked using ethanolamine, the DNA immobilized on the silicon surface was hybridized with complementary DNA conjugated with about 13 nm of Au nanoparticles.

The unreacted and remaining aldehyde group was substituted to hydroxyl group having weak reactivity with DNA by exposing the silicon substrate surface to ethanolamine and NaBH₃CN.

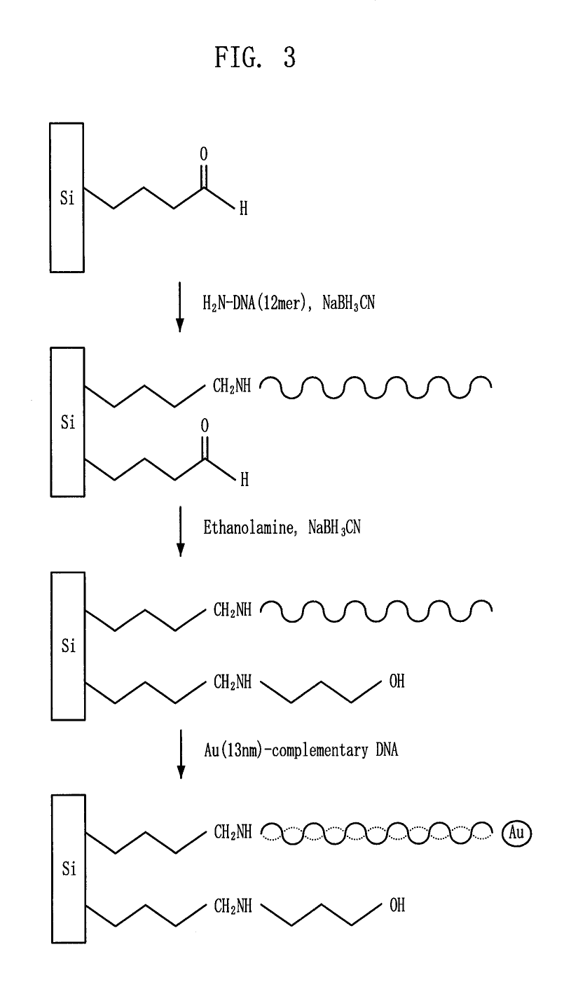

Then, about 13 nm gold nanoparticle was conjugated with complementary DNA, which could be complementary-bonded with the immobilized DNA on the silicon surface in about pH 7 of 0.3M NaCl, about 0.025% SDS, and 10 mM phosphate buffer solution for about six hours. After reacting, it was cleaned using 0.3M an ammonium acetate solution, thereby selectively immobilizing Au-DNA on an unmodified silicon substrate surface as shown in FIG. 3.

After reacting, the silicon substrate surface was observed through a scanning electron microscope (SEM).

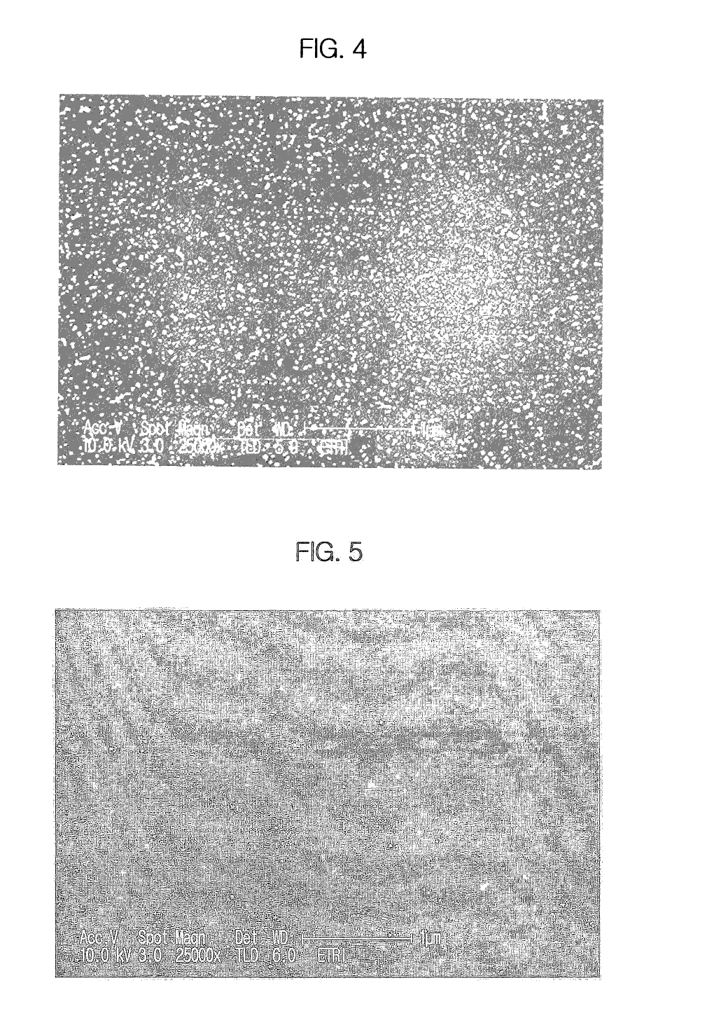

The result is shown in FIGS. 4 and 5.

As shown in FIGS. 4 and 5, the SEM images clearly show that the Au-DNA is immobilized on the unmodified silicon substrate surface and the Au-DNA was not immobilized on modified silicon oxide substrate.

### 2^{nd} Experimental Example

### Experiment for Confirming Protein Immobilization on Unmodified Silicon Substrate Surface

A second experiment was performed to confirm that protein is immobilized on an unmodified silicon substrate surface only.

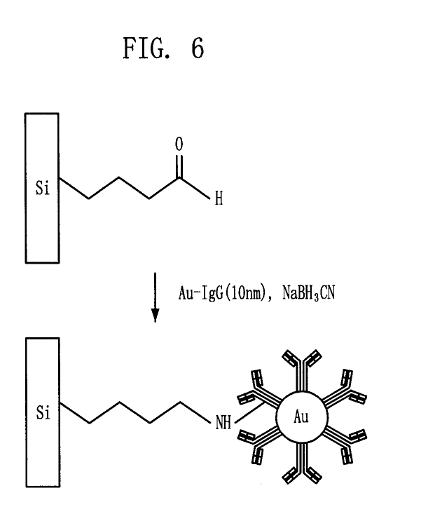

Au-IgG bonding was made by bonding about 10 nm of gold particles with IgG. Then, the Au-IgG conjugates reacted with the aldehyde-functionalized silicon surface in a reducing agent NaBH₃CN for about twelve hours, thereby selectively immobilizing the Au-IgG conjugates on the unmodified silicon substrate surface as shown in FIG. 6.

After reacting, the silicon substrate surface was observed through a scanning electron microscope (SEM).

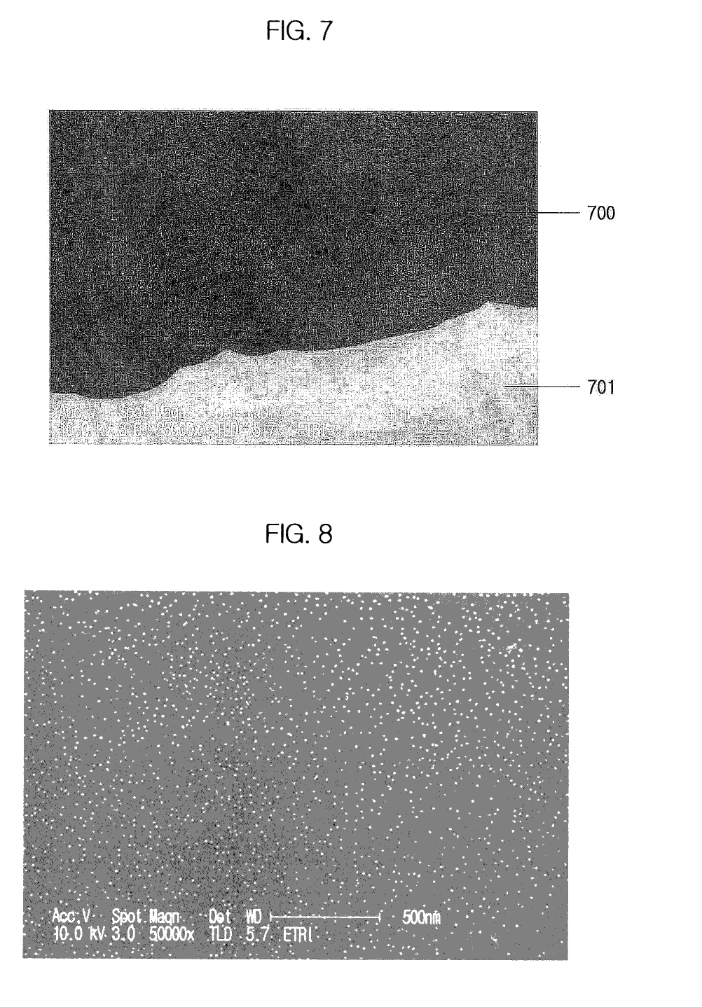

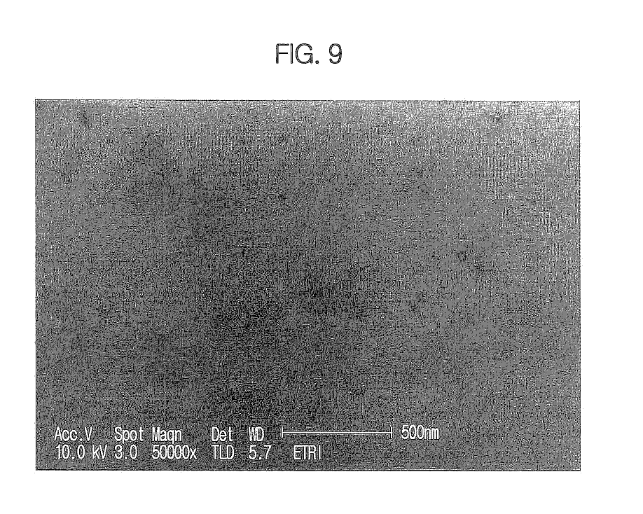

FIGS. 7 and 9 show the SEM images of the silicon substrate surface.

FIG. 7 is a SEM image showing both a silicon substrate surface and silicon oxide substrate surface. As shown, the SEM image clearly shows that the Au-IgG conjugates were immobilized on the unmodified silicon substrate surface 700 and the Au-IgG conjugates were not immobilized on the modified silicon oxide substrate surface 701.

FIGS. 8 and 9 are magnified SEM images of FIG. 7. Also, the magnified SEM images of FIGS. 8 and 9 clearly show that the Au-IgG conjugates are immobilized on the unmodified silicon substrate surface and the Au-IgG conjugates are not immobilized on the modified silicon oxide substrate surface.

What is claimed is:

1. A method for selectively functionalizing an unmodified solid surface, comprising the steps of:
a) functionalizing an unmodified solid surface, which is not oxidized and nitrified, using a functional group that reacts with light;
b) introducing a chemical compound onto the solid surface, which contains an aldehyde protecting group and a functional group, that reacts with the functionalized surface;
c) forming surface-carbon bonding, surface-nitrogen bonding, or surface-sulfur bonding by radiating light on the solid surface, and functionalizing the surface end to aldehyde protecting group; and
d) functionalizing the solid surface into aldehyde group by removing the protecting group from the solid surface functionalized with the aldehyde protecting group.

2. The method of claim 1, wherein the solid is one selected from the group consisting of crystal or amorphous solid having group IV elements, semiconductor compound, plastic, polymer, and metal.

3. The method of claim 1, wherein the functional group reacting with the light is one selected from the group consisting of hydrogen, hydrocarbon, hydroxyl group, carbonyl group, amino group and thiol group.

4. The method of claim 1, wherein in the step a), the solid surface is immersed in about 0.01 to 10% buffered oxide etch (BOE) solution for about 0.01 second to 60 hours.

5. The method of claim 1, wherein the functional group reacting with the surface, one selected from the group consisting of an end or a branch, acyclic or cyclic unsaturated hydrocarbon group, thiol group, carbonyl group, carboxyl group, amino group, imino group, nitro group, hydroxyl group, phenyl group, nitrile group, isocyano group, and isotiocyano group.

6. The method of claim 1, wherein the aldehyde protecting group is one of acyclic acetal group and cyclic acetal group.

7. The method of claim 1, wherein in the step c), one of infrared rays, visible rays, ultraviolet rays, and X-rays is radiated for about one minute to 24 hours.

8. The method of claim 1, wherein the step d) is performed by an acid, a base, an oxidizing agent, a reducing agent, electricity, heat, or light.

9. The method of claim 1, wherein in the step d), about 10 to 50% a trifluoroacetic acid solution is added to the solid surface, and the trifluoroacetic acid solution reacts with the solid surface at about −10 to 60° C. for about 10 minutes to five hours.

10. A method for immobilizing an active material on an unmodified solid surface, comprising the step of:
immobilizing an active material on a solid surface functionalized into aldehyde group using the method for claim 1.

11. The method of claim 10, wherein the active material is at least one selected from the group consisting of a bio material, a functional material, a nano material, and a polymer.

12. The method of claim 10, further comprising the step of:
forming or substituting a functional group that reacts with aldehyde group on an active material before the active material is immobilized on a solid surface.

13. The method of claim 12, wherein the functional group reacting with the aldehyde group is at least one selected from the group consisting of amino group, hydrazine group, hydrazone group, cyano group, isocyano group, isothiocyano group, halogen group, nitro group, alcohol group, thiol group, and grignard compound.
